(19) United States
(12) Patent Application Publication
(10) Pub. No.: US 2005/0056589 A1
(43) Pub. Date: Mar. 17, 2005

(54) Treatment of semi-permeable filtration membranes

(75) Inventors: Robert A. Hendel, Chalfont, PA (US); Jean M. Lovett, Hillsborough, NJ (US)

Correspondence Address: WEGMAN, HESSLER & VANDERBURG, 6055 ROCKSIDE WOODS BOULEVARD, SUITE 200, CLEVELAND, OH, 44131, US

(73) Assignee: General Electric Company, Fairfield, CT (US)

(21) Appl. No.: 10/663,585

(22) Filed: Sep. 16, 2003

(51) Int. Cl. B01D 61/00

(52) U.S. Cl. 210/639; 210/650; 210/778

(57) ABSTRACT

Methods of enhancing performance of a semi-permeable filtration membrane such as a polyamide R.O. membrane. A water soluble polymer is brought into contact with the membrane structure and is characterized by the Formula I 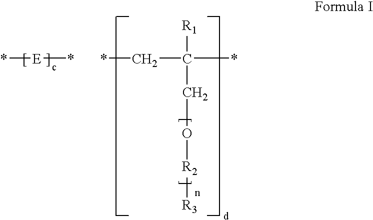
wherein E is a repeat unit remaining after polymerization of an ethylenically unsaturated monomer or mixtures thereof; R₁ is hydrogen or C₁-C₄ alkyl; R₂ is C₁-C₆ alkyl, C₁-C₆ alkylene, di-hydroxy substituted C₁-C₆ alkyl, di-hydroxy substituted C₁-C₆ alkylene, aryl, or mixtures thereof; n is 0 to about 100; R₃ is OH, SO₃Z OSO₃Z, PO₃Z₂, OPO₃Z₂, CO₂Z, or mixtures thereof; Z is hydrogen or a water-soluble cation; and the mole ratio c:d ranges from about 30:1 to 1:20 respectively.

### FIELD OF INVENTION

The present invention relates to a method for treating a semi-permeable filtration method membrane to improve membrane performance.

### BACKGROUND OF THE INVENTION

Reverse osmosis and nanofiltration membranes are used to separate dispersed or dissolved material from a solvent or dispersing medium, usually water. These membranes are selectively permeable, and the process usually involves bringing the aqueous feed solution into contact with the membrane under increased pressure conditions on the upstream side of the membrane so that the aqueous phase will flow through the membrane while permeation of the dissolved or dispersed materials is prevented.

Both reverse osmosis and nanofiltration membranes typically are in the form of a composite structure comprising a discriminating layer fixed to a porous support layer. The support layer provides strength while the discriminating layer rejects the dissolved or dispersed materials from the aqueous phase. Reverse osmosis (R.O.) discriminating layers are typically impermeable to all ions including sodium and chloride and for that reason are used for desalination, and purification of brackish water. Sodium Chloride rejection rates for reverse osmosis membranes are generally on the order of about 95%-100%. Additionally, reverse osmosis membranes may be used to clean wastewater from a number of industrial sources.

Nanofiltration membranes generally have higher fluxes than reverse osmosis membranes but have salt rejection rates of less than about 95%. These membranes are effective in rejecting divalent ions such as Mg, Ca, SO₄ and NO₃. Additionally, these membranes are generally impermeable to organic compounds having molecular weight in excess of about 200. Nanofiltration membranes find particular utility in applications such as water softening and the removal of organics from water. Reverse osmosis and nanofiltration discriminating layer semi-permeable membranes may be composed of a variety of materials such as cellulose acetate and polyamide polymers. Most commercially available R.O. membranes are polyamide polymer products such as those formed via reaction of a polyfunctional aromatic amide with an acyl halide as described in U.S. Pat. No. 4,277,344. Other specific amide polymer types are disclosed in U.S. Pat. Nos. 4,769,148; 4,859,384; 4,765,897; 4,812,270; and 4,824,574.

In order to enhance the performance value of these semi-permeable filtration membranes, it is desirable to employ treatments to increase the rejection rate of the dissolved solute or dispersed matter while not adversely affecting flux or fluid flow through rates. Additionally, treatments are desired that can control deposit formation along membrane surfaces so that maximum membrane surface area is available to perform the desired filtration function.

### SUMMARY OF THE INVENTION

We have found that certain water-soluble or water-dispersible polymers, when added to the water system in contact with semi-permeable filter membranes such as a polyamide R.O. or nanofiltration membranes will effectively increase salt rejection rates while maintaining or improving the flux. Additionally, the treatments are effective in inhibiting scale formation such as calcium phosphate scale that would normally form along membrane surfaces, and impede membrane flux and overall separation efficacy.

Although the invention finds particular utility in the treatment of the thin film polyamide membranes that are typically employed in R.O. and nanofiltration filtration methods, it is applicable in a broader sense to all semi-permeable separation membranes including those used in processes such as microfiltration, ultrafiltration, and multimedia filtration. In addition, the utility of the invention is not limited by the material of construction of the membrane.

In accordance with the invention, from about 1 to about 10,000 ppm (based upon one million parts of water) of a water-soluble or water-dispersible polymer having the Formula I is added to the water system in contact with the semi-permeable membrane. These polymers contain a functional allyl monomer component and are characterized by the Formula I 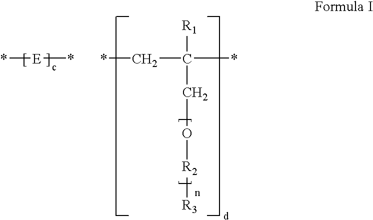
wherein E is the repeat unit after polymerization of an ethylenically unsaturated monomer, or mixtures thereof; R₁ is hydrogen or C₁-C₄ alkyl; R₂ is C₁-C₆ alkyl, C₁-C₆ alkylene, di-hydroxy substituted C₁-C₆ alkyl, di-hydroxy substituted C₁-C₆ alkylene, aryl, or mixtures thereof; n is 0 to about 100; R₃ is OH, SO₃Z, OSO₃Z, PO₃Z₂, OPO₃Z₂, CO₂Z, or mixtures thereof; Z is hydrogen or a water-soluble cation; and the mole ratio c:d ranges from about 30:1 to 1:20, respectively.

The invention will be further described in conjunction with the drawings herein.

### BRIEF DESCRIPTION OF THE DRAWINGS

FIG. 1 is a graph showing normalized flow rate, and salt rejection of an R.O. membrane comparing a treatment in accordance with the invention to no treatment;

FIG. 2 is a graph similar to FIG. 1 showing a repeat run for the treatment in accordance with the invention compared to no treatment;

FIG. 3 is a graph showing normalized flow rate of an R.O. membrane in an aqueous medium prone to deposit formation where a polymer treatment in accordance with the invention is compared to no treatment;

FIG. 4 is a graph similar to that shown in FIG. 3 showing salt rejection of an R.O. membrane in an aqueous medium prone to deposit formation comparing a polymer treatment of the invention versus no treatment; and

FIG. 5 is a graph showing the % PO₄ Inhibition and Turbidity via bottle testing for waters that contain 200 ppm PO₄ (as PO₄), 1000 ppm Ca (as CaCO₃), 20 ppm M-Alk (as CaCO₃), at pH 7.5, with various treatments.

### DETAILED DESCRIPTION

We have found that the performance of a R.O. membrane is improved when the polymeric treatment agents of the invention are added to the liquid carrier medium, usually water, preferably at a location upstream from the membrane. The treatment may also be applied directly to the membrane itself by spraying or immersion efforts. Since the liquid carrier medium contacts the membrane during operation of the system, direct contact of the membrane by the treatment is intended to fall within the ambit of the broader concept of adding the treatment to the liquid carrier or aqueous phase.

The polymeric treatment may be added in an amount of about 1-10,000 parts treatment per million parts of the water and a preferred addition amount is from about 1-2,000 ppm of the treatment.

The treatment provides advantage in that salt rejection of the membrane is improved while the flow rate or flux through the membrane remains substantially unaffected by the treatment. Additionally, scale formation on the membrane is inhibited. Scale formation on the membrane surface, if untreated, may severely impair the system throughput. The polymer treatment has shown efficacy in inhibiting calcium phosphate scale formation.

The polymeric treatment agents of the invention are characterized by the Formula I 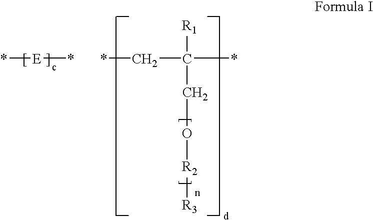
wherein E is the repeat unit after polymerization of an ethylenically unsaturated monomer, or mixtures thereof; R₁ is hydrogen or C₁-C₄ alkyl; R₂ is C₁-C₆ alkyl, C₁-C₆ alkylene, di-hydroxy substituted C₁-C₆ alkyl, di-hydroxy substituted C₁-C₆ alkylene, aryl, or mixtures thereof; n is 0 to about 100; R₃ is OH, SO₃Z, OSO₃Z, PO₃Z₂, OPO₃Z₂, CO₂Z, or mixtures thereof; Z is hydrogen or a water-soluble cation; and the mole ratio c:d ranges from about 30:1 to 1:20, respectively.

In a preferred embodiment of the invention E is the repeat unit after polymerization of an anionic ethylenically unsaturated monomer, or mixtures thereof; R₁ is hydrogen; R₂ is —CH₂—CH₂—, n is 1 to about 20; R₃ is OH, SO₃Z, or OSO₃Z, or mixtures thereof; Z is hydrogen or a water-soluble cation such as Na, K, or NH₄; and the mole ratio c:d ranges from about 15:1 to 1:10, respectively.

In a particularly preferred embodiment of the invention E is the repeat unit after polymerization of acrylic acid; R₁ is hydrogen; R₂ is —CH₂—CH₂—; n is 5 to about 20; R₃ is OSO₃Z; Z is hydrogen or a water-soluble cation such as Na, K, or NH₄; and the mole ratio c:d ranges from about 15:1 to 2:1, respectively.

With respect to E of Formula 1, this may comprise the repeat unit obtained after polymerization of a carboxylic acid, sulfonic acid, phosphonic acid, or amide form thereof or mixtures thereof. Exemplary compounds include but are not limited to the repeat unit remaining after polymerization of acrylic acid (AA), methacrylic acid, acrylamide, methacrylamide, N-methyl acrylamide, N,N-diemethyl acrylamide, N-isopropylacrylamide, maleic acid or anhydride, fumaric acid, itaconic acid, styrene sulfonic acid, vinyl sulfonic acid, isopropenyl phosphonic acid, vinyl phosphonic acid, vinylidene di-phosphonic acid, 2-acrylamido-2-methylpropane sulfonic acid and the like and mixtures thereof. Water-soluble salt forms of these acids are also within the purview of the present invention. More than one type of monomer unit E may be present in the polymer of the present invention.

Exemplary monomers that may comprise the repeat unit after polymerization of an allyl monomer include, but are not limited to, 1-allyloxy-2,3-propanediol, hydroxypolyethoxy(10) allyl ether (PEGAE), allyloxy benzenesulfonate, and ammonium allylpolyethoxy(10) sulfate (APES).

The preparation of the polymers of the present invention may proceed in accordance with solution, emulsion, micelle or dispersion polymerization techniques. Conventional polymerization initiators such as persulfates, peroxides, and azo type initiators may be used. The polymerization may also be initiated by radiation or ultraviolet mechanisms. Chain transfer agents such as isopropanol, allyl alcohol, amines, hypophosphorous acid, phosphorous acid, mercapto compounds, and the like, may be used to regulate the molecular weight of the polymer. Branching agents such as methylene bisacrylamide, or polyethylene glycol diacrylate and other multifunctional crosslinking agents may also be added. The resulting polymer may be isolated by precipitation or other well-known techniques. If polymerization is in an aqueous solution, the polymer may simply be used in the aqueous solution form. Exemplary polymerization procedures, for which it is to be understood do not in any way limit the synthesis of the polymers of the present invention, are described by Chen et al. in U.S. Pat. Nos. 4,659,481; 4,701,262; 5,180,498; and 6,444,747. The disclosure of these patents is incorporated by reference herein.

The polymeric treatments of the invention may be conjointly used with traditional antiscalants and/or biocides. For example, a combined treatment may include polymer of the present invention and 1-hydroxyethane 1,1-diphosphonic acid (HEDP); aminotri(methylenephosphonic acid) (ATMP); diethylenetriaminepenta(methylenephosphonic acid) (DETPMP); 2-hydroxyethyliminobis(methylenephosphonic acid) (HEBMP); polyacrylic acids; hexamethylenediaminetetra(methylenephosphonatei) potassium salt (HMTP); bis(hexamethylene)triaminepenta(methylenephosphonic acid) (BHMTPMP); and mixtures thereof.

Additionally, the polymers may be used in the aqueous system in combination with traditional biocidal agents such as tetrakishydroxymethylphosphonium sulfate (THPS), poly (oxyethylene-(dimethylimino)ethylene(dimethylimino)ethylenedichloride) (WSCP), or any combinations thereof.

The invention will be further described in conjunction with the following specific examples that are to be regarded solely as illustrative and not as restricting the scope of the present invention.

### EXAMPLES

### Example 1

### Polymerization of Acrylic Acid with Allyloxypolyethoxy(10) Sulfate (AA/APES)

This sample was prepared as described in Example 2 of Chen et al. U.S. Pat. No. 6,444,747 except a solution of sodium hypophsophite (2.5 mole % of the total monomer charge) was co-fed to the reactor during the first hour of the sodium persulfate feed. The product was then adjusted to pH ˜5 with 50% caustic, adjusted to ˜50% solids with DI water, and then isolated as an aqueous solution.

The structure of the resulting polymer was verified by ¹³C and ³¹P NMR. The viscosities of samples prepared by this method typically ranged from 150-300 cps.

### Example 2

### Salt Rejection and Flow Studies

A standard recirculating cross flow testing unit was used to determine whether the treatments in accordance with the invention were effective in improving membrane performance of an R.O. polyamide membrane, specifically a TFC (Thin Film Composite) membrane Filmtec™ BW30. The treating unit included a 15 L holding tank that was provided upstream from the R.O. membrane separator unit. Both reject and permeate from the R.O. separator were recycled back to the holding tank.

System Operating Parameters were as follows.
Transmembrane Pressure (TMP)=225 psig
Feed Flow Rate=1.25 GPM
Reject Flow Rate=1.0 GPM
Temperature=25.0+/−0.5° C. (controlled via a circulating chiller bath)
pH=7.0+/−0.5
Membrane=Filmtec™ BW30 (TFC polyamide, wet tested); 21.5 in²
Treatment: concentrated stock shot fed into system

Differences in normalized flow (NF) and normalized salt rejection (Rn) were determined upon addition of the treatment compared to no treatment. Throughputs (i.e., flow or flux) and salt rejection were measured.

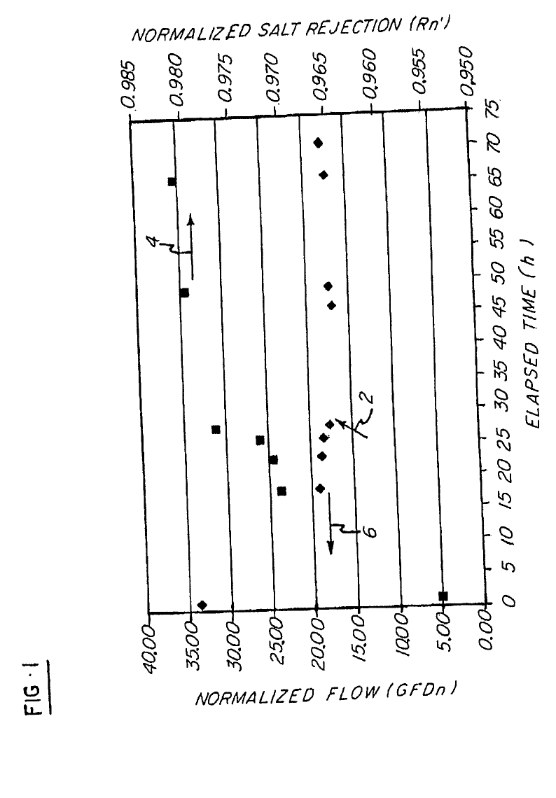

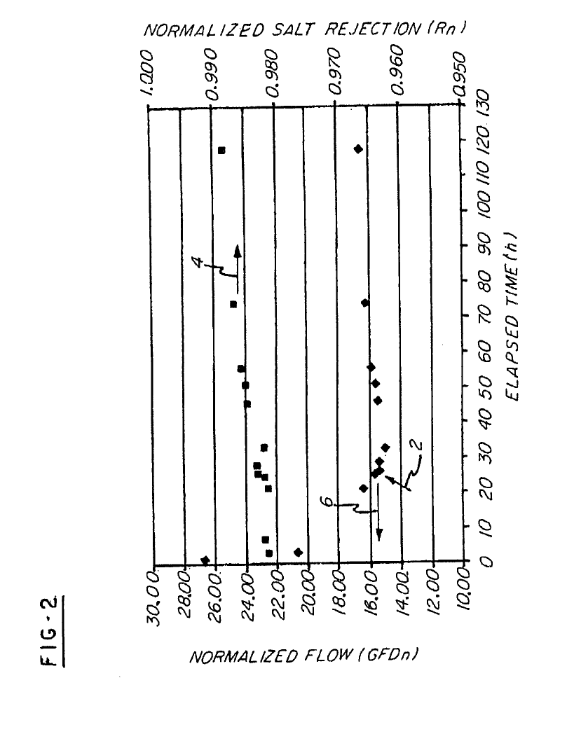

Results of two tests using 15 ppm active AA/APES as the polymer treatment are shown in FIGS. 1 and 2. System operating parameters for these tests were as follows.
Treatment: AA/APES 15 ppm active
Aqueous Medium: 2,000 ppm MgSO₄
T=25.0° C.
pH=7.0
TMP=225 psig
Reject Flow Rate 1.0 GPM
75 GPH pump head (303 SS)

FIG. 1 demonstrates that upon addition of the AA/APES to the recirculating R.O. system water as shown by reference numeral 2, normalized salt rejection (arrow 4 and the squares) increased while the flow rate (arrow 6 and the diamond shapes) remained about the same. In FIG. 2, a slight increase in salt rejection 4 is shown when the AA/APES polymer is admitted 2 into the recirculating water systems while normalized flow 6 remains largely the same.

### Example 3

### Calcium Phosphate Inhibition

In order to demonstrate efficacy of the invention in inhibiting scale formation in R.O. membrane systems, bottle tests were undertaken in an aqueous medium of the type prone to formation of calcium phosphate scale. In the bottle tests, synthetic waters were prepared with and without chemical treatment (e.g., no treatment and AA/APES), and varying levels of alkalinity, hardness, and phosphate. These waters simulate the concentrate from the last stage in a typical R.O. system. The waters were prepared so that calcium phosphate was the only possible scaling species. The bottles were agitated for one hour at 25° C., and then turbidities were measured and visual appearances were recorded. Water aliquots were then obtained and filtered through 0.2 μm filters and then analyzed via ICP-AE for PO₄ levels. Differences in PO₄ levels and turbidities between the non-treated and treated samples were used as the criteria for efficacy. The ideal case is to recover all PO₄ and to have low turbidity.

Results are shown in Tables I and II following:

TABLE I^{(e)}

| Treatment | | | PO₄^{(b)} | Theoretical |
|---|---|---|---|---|
| Dosage^{(d)} | Appearance | Turbidity^{(a)} | ppm | PO₄^{(c)} |
| Ppm | t = 1 hr | NTU | (After 1 hr) | ppm |
| 0 | Clear | 0.131 | 9.7 | 9.9 |
| 0 | Clear | 0.33 | 28 | 28.3 |
| 0 | Clear | 0.597 | 47.4 | 48.7 |
| 0 | Hazy | 2.02 | 59.4 | 67 |
| 0 | Hazy | 6.17 | 78.2 | 98.3 |
| 0 | Hazy | NM | 71.3 | 124 |
| 0 | Hazy | NM | 82.7 | 147 |
| 25 | Clear | 0.116 | 10 | 9.9 |
| 25 | Clear | 0.147 | 33.1 | 28.3 |
| 25 | Clear | 0.224 | 49.5 | 48.7 |
| 25 | Clear | 0.171 | 75 | 67 |
| 25 | Clear | 0.358 | 115 | 98.3 |
| 25 | Clear | 0.176 | 128 | 124 |
| 25 | Clear | 0.448 | 169 | 147 |
| 50 | Clear | NM | 10.3 | 9.9 |
| 50 | Clear | NM | 32.3 | 28.3 |
| 50 | Clear | NM | 49.5 | 48.7 |
| 50 | Clear | NM | 73.8 | 67 |
| 50 | Clear | NM | 107 | 98.3 |
| 50 | Clear | NM | 126 | 124 |
| 50 | Clear | NM | 161 | 147 |

^{(a)}NM = not measured
^{(b)}PO₄ level after 1 h (filtered through a 0.2 μm filter)
^{(c)}Theoretical level: anions and DI water only (no hardness)
^{(d)}Treatment = AA/APES (active)
^{(e)}Synthetic waters consisted of 1000 ppm Ca (as CaCO₃), variable levels of PO₄ (as PO₄, see table), pH = 7.5 (at start)

Table I indicates that AA/APES was effective in inhibiting calcium formation and resulted in clearer filtrate.

TABLE II^{(e)}

| Treatment | | | PO₄^{(b)} | Theoretical |
|---|---|---|---|---|
| Dosage^{(d)} | Appearance | Turbidity^{(a)} | ppm | PO₄^{(c)} |
| Ppm | T = 1 hr | NTU | (After 1 hr) | ppm |
| 0 | Clear | 0.28 | 8.86 | 9.71 |
| 0 | Hazy and Floc | NM | 15.3 | 25.1 |
| 0 | Hazy and Floc | NM | 26.1 | 46.4 |
| 0 | Hazy and Floc | NM | 30.2 | 54.7 |
| 0 | Hazy and Floc | NM | 48.8 | 97.3 |
| 25 | Clear | 0.121 | 10 | 9.71 |
| 25 | Clear | 0.194 | 25.3 | 25.1 |
| 25 | Clear | 0.569 | 46.4 | 46.4 |
| 25 | Clear | 0.587 | 55.3 | 54.7 |
| 25 | Clear | 3.5 | 98.8 | 97.3 |
| 50 | Clear | 0.213 | 10.2 | 9.71 |
| 50 | Clear | 0.111 | 25.5 | 25.1 |
| 50 | Clear | 0.169 | 46.9 | 46.4 |
| 50 | Clear | 0.201 | 55.4 | 54.7 |
| 50 | Clear | 1 | 98.4 | 97.3 |

^{(a)}NM = not measured
^{(b)}PO₄ level after 1 h (filtered through a 0.2 μm filter)
^{(c)}Theoretical level: anions and DI water only (no hardness)
^{(d)}Treatment = AA/APES (active)
^{(e)}Synthetic waters consisted of 1000 ppm Ca (as CaCO₃), variable levels of PO₄ (as PO₄, see table), pH = 8.3 (at start)

Table II again demonstrates the effectiveness of the AA/APES treatment in inhibiting CaPO₄ scale formation and providing a clearer filtrate.

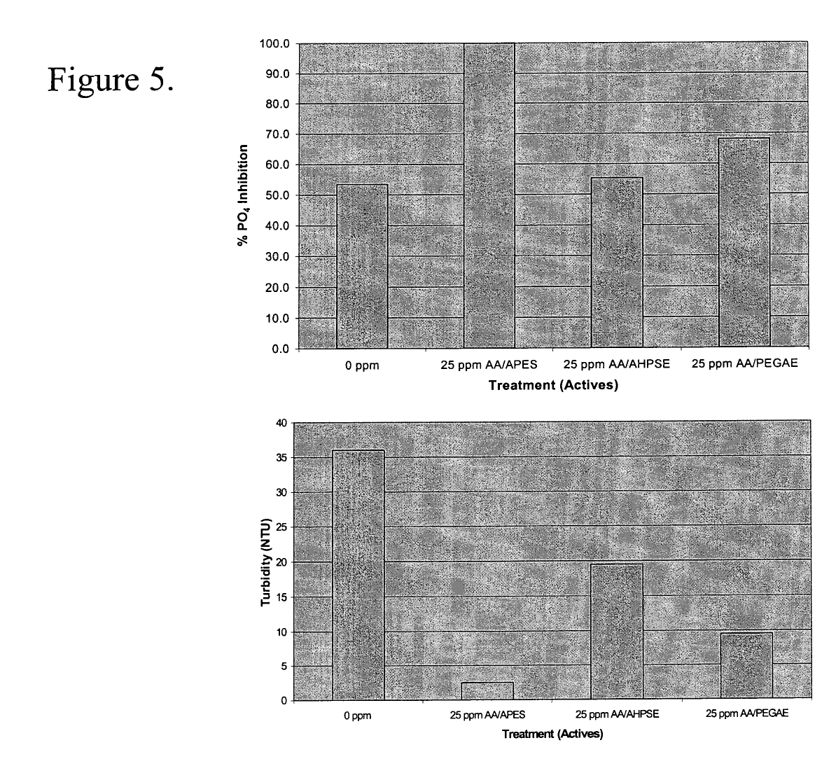

FIG. 5 includes bottle test results for—additional treatments prepared in accordance with Chen et al. as detailed in U.S. Pat. Nos. 4,659,481 and 5,180,498. The test water contained—1000 ppm Ca (as CaCO₃), 200 ppm PO₄ (as PO₄), 20 ppm M-Alk (as CaCO₃) at pH 7.5. Clearly, efficacy is observed for each of the samples as compared to the No Treatment case (0 ppm). Also note that subtle changes in molecular structure can influence performance.

### Example 4

### Salt Rejection and Flow Studies in Scale Prone Aqueous Medium

The cross flow testing unit described above was employed to study polymer treatment performance in inhibiting scaling in an aqueous medium having calcium phosphate scale forming species therein.

System Operating Parameters were
Recirculating water: 1000 ppm Ca (as CaCO₃), 50 ppm PO₄ (as PO₄)
T=25° C.
TMP=225 psig
Reject Flow Rate: 1 GPM
75 GPH pump head (316 SS)
20 ppm M-Alk (from NaHCO₃)
pH 7.3
Membrane: Polyamide R.O. Filmtec™ BW30
Polymer Treatment=AA/APES, 50 ppm active.

In these tests, the waters were prepared in the same way as reported in the Bottle Tests (Example 3), except at a larger scale. The waters were prepared so that calcium phosphate was the only possible scaling species. Similar to the bottle testing, this situation simulates the concentrate in the last stage of many R.O. systems. In all cases, the pH of the starting water was pH 7.5 before the formation of calcium phosphate. The reduction in pH, if any, was dependent on the amount of calcium phosphate formed; pH was not controlled via the addition of base to pH 7.5.

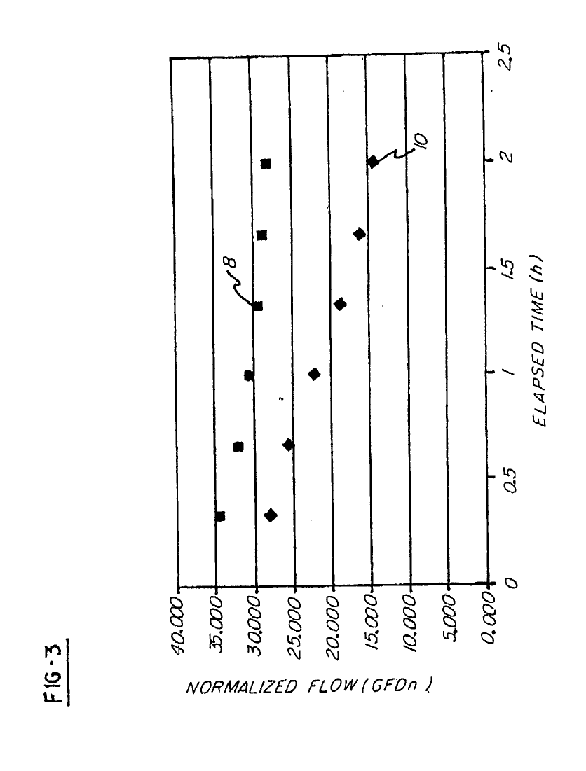

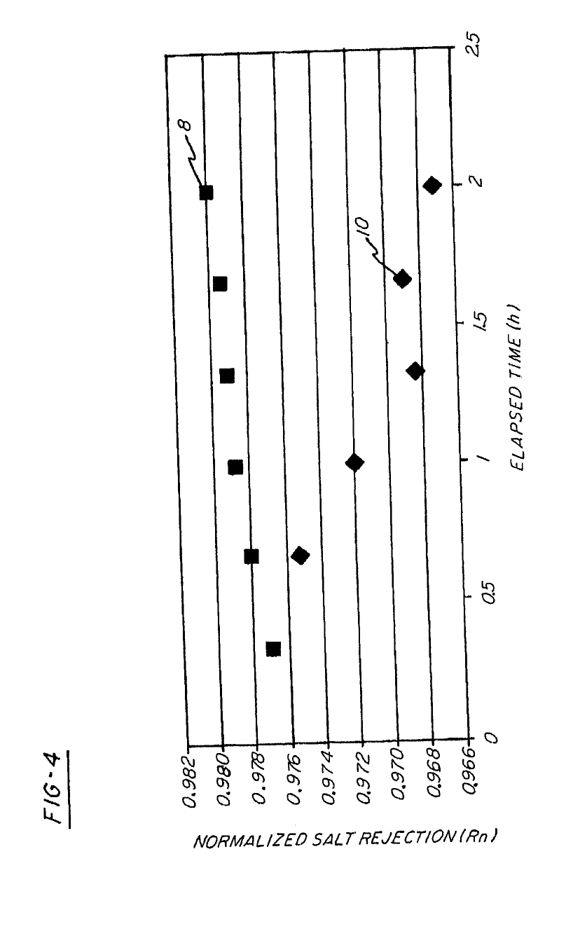

Results showing normalized flow rate with and without polymer treatment are shown graphically in FIG. 3. In these graphs, reference number 8 indicates treatment data with number 10 indicating no treatment. FIG. 4 indicates normalized salt rejection rates for the treatment 8 versus control 10. These graphs indicate that the AA/APES treatment provides a normalized flow that is consistent with a clean polyamide membrane (FIG. 3) while salt rejection (FIG. 4) has improved by use of treatment 8 in a R.O. membrane contacting water system that would, without treatment, form scale.

### Example 5

### Membrane Studies

Additionally, surface analysis of the R.O. membranes used in Example 4 was made. The membranes were analyzed by Scanning Electron Microscopy (SEM) and Energy Dispersive X-ray Spectroscopy (EDAX).

SEM photos of the treated versus the untreated membrane show that at 1000×, the non-treated membrane was plagued by the presence of calcium phosphate scale crystals ranging in size from about 10-20 μm. Addition of 50 ppm active of AA/APES to the recirculating water resulted (1000×, SEM) in a uniform membrane appearance devoid of large calcium phosphate crystals. EDAX ZAF quantification of the membranes revealed a marked decrease in P and Ca elements at the membrane surface. Results of this quantification are contained in Table III.

TABLE III

| | Element | wt % |
|---|---|---|
| No Treatment | O | 47 |
| | P | 16 |
| | S | 7 |
| | Ca | 30 |
| | Total | 100 |
| 50 ppm active AA/APES | O | 54 |
| | P | 5 |
| | S | 31 |
| | Ca | 10 |
| | Total | 100 |

FIG. 5 graphically demonstrates improved results in calcium phosphate inhibition and reduced turbidity tests for the AA/APES and AA/PEGAE polymer treatments compared with an AA/AHPSE (comparative) polymer treatment. AA/AHPSE polymers have been used in reverse osmosis systems for some time. These are acrylic acid/allyl hydroxy propyl sufonate ether polymers as reported in U.S. Pat. No. 4,659,481.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

1. Method of treating a semi-permeable filter membrane of the type that separates a dissolved or dispersed material from a liquid carrier medium that is brought into contact with said membrane, said method comprising contacting said liquid carrier medium with an effective amount of a treatment agent comprising repeat units having the formula: 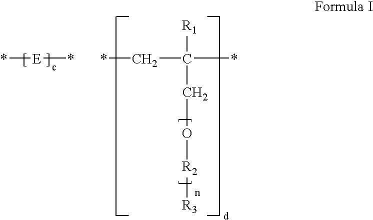
wherein E is a repeat unit remaining after polymerization of ethylenically unsaturated monomer; R₁ is hydrogen or C₁-C₄ alkyl; R₂ is C₁-C₆ alkyl, C₁-C₆ alkylene, di-hydroxy substituted C₁-C₆ alkyl, di-hydroxy substituted C₁-C₆ alkylene, aryl, or mixtures thereof; n is 0 to about 100; R₃ is OH, SO₃Z, OSO₃Z, PO₃Z₂, OPO₃Z₂, CO₂Z, or mixtures thereof; Z is hydrogen or a water-soluble cation; and the mole ratio c:d ranges from about 30:1 to 1:20, respectively.

2. Method as recited in claim 1 wherein said liquid carrier medium comprises water and said treatment is added to said water in an amount of about 1-10,000 ppm based upon one million parts of said water.

3. Method as recited in claim 2 wherein said treatment is added in an amount of about 1-2,000 ppm.

4. Method as recited in claim 1 wherein [E] is a repeat unit remaining after polymerization of acrylic acid or water soluble salt thereof.

5. Method as recited in claim 4 wherein R₁ is hydrogen, R₂ is —CH₂CH₂—, n is 1 to about 20, R₃ is OH, SO₃Z, or OSO₃Z, or mixtures thereof; Z is hydrogen or a water soluble cation such as Na, K, or NH₄, and the mole ratio c:d ranges from about 15:1 to 1:10.

6. Method as recited in claim 5 wherein R₁ is hydrogen, R₂ is —CH₂—CH₂; n is about 5 to about 20; R₃ is OSO₃Z, Z is hydrogen or a water soluble cation such as Na, K, or NH₄, and the mole ratio of c:d ranges from about 15:1 to 2:1.

7. Method as recited in claim 1 comprising spraying or pouring an aqueous solution or dispersion containing said treatment agent on said membrane or immersing said membrane in an aqueous solution containing said treatment agent.

8. Method as recited in claim 1 wherein said membrane is a polyamide R.O. membrane.

9. Method as recited in claim 2 wherein said water comprises Ca cations in amounts sufficient to form calcium containing scale in the absence of addition of said treatment agent, and wherein said treatment agent inhibits the formation of said scale along a surface of said membrane.

10. Method as recited in claim 9 wherein said scale is calcium phosphate.

11. Method as recited in claim 10 wherein said treatment agent is a member selected from the group consisting of AA/APES; AA/PEGAE, AA/1-allyloxy-2,3 propanediol, and mixtures thereof.

12. Method as recited in claim 11 wherein said treatment agent is AA/APES.

13. Method as recited in claim 11 wherein said treatment agent is AA/PEGAE.
